(19) United States
(12) Patent Application Publication
(10) Pub. No.: US 2009/0114104 A1
(43) Pub. Date: May 7, 2009

(54) Drying Device With Improved Drive Mechanism

(76) Inventors: Ravi Kumar Sawhney, Calabasas, CA (US); Kurt Gregory Botsai, Thousand Oaks, CA (US); John Mark Vernon, Malibu, CA (US); Christopher Glupker, North Hills, CA (US); Simon Risley, Ventura, CA (US); Sanjay Choudhuri, Mission Viejo, CA (US); Jason Alan Dimas Rico, Mission Viejo, CA (US); Patrice Gerber, Laguna Beach, CA (US)

Correspondence Address: BRINKS HOFER GILSON & LIONE, P.O. BOX 10395, CHICAGO, IL, 60610, US

(21) Appl. No.: 12/261,812

(22) Filed: Oct. 30, 2008

Related U.S. Application Data
(60) Provisional application No. 60/985,011, filed on Nov. 2, 2007.

(51) Int. Cl. A47J 43/04; B04B 9/00; F26B 17/30; F26B 5/08

(52) U.S. Cl. 99/495; 494/84; 34/58; 34/322

(57) ABSTRACT

A drying device having a bowl, a basket with a plurality of perforations, a cover assembly, and a drive assembly. The drive assembly includes: a driving mechanism mechanically coupled to a rotatable lid that is configured to mate with a rotatable basket, and a handle pivotally attached to the cover assembly. The handle is configured to actuate the driving mechanism upon rotation of the handle about an axis from a first position to a second position. The drying device may also include a locking mechanism and/or a braking mechanism.

### CONTINUTITY

The current application claims priority to the U.S. provisional application filed on Nov. 2, 2007 entitled Salad Spinner with Improved Drive Mechanism, having the Ser. No. 60/985,011, which is incorporated by reference.

### BACKGROUND

1. Technical Field

The present invention generally relates to drying devices and, more particularly, to a spinner device configured to dry food and other items.

### Background Information

It is often desirable to rinse items, such as food, to remove unwanted dirt, chemicals, or other debris. In doing so, however, the excess moisture that remains on the items can be undesirable. This is particularly the case with lettuce and other salad greens, which tend to retain moisture, and thus, may be difficult to coat with oil-based dressings when the leaves are wet.

To solve this problem, some manufacturers have developed vegetable drying devices, or “salad spinners.” These drying devices typically use a rotating basket to remove moisture through centrifugal force. Rotation of the basket is generally accomplished through an electrical or mechanical driving mechanism. Such devices are unsatisfactory in a number of respects.

Some mechanical drying devices use a crank to rotate the basket. Such cranks tend to be slippery and require the user to continuously move within a single plane (i.e., the plane defined by the crank), while holding the drying device to keep it steady. It is thus difficult and tiresome to grasp and move the crank repeatedly while stabilizing the drying device.

Other mechanical drying devices include a pull handle attached to the device by a cord. These devices require the user to use one hand to hold the cover of the device stationary and the other hand pulls the handle.

Other known drying devices use a pumping actuator to rotate the basket. These drying devices require the user to push the handle directly downward. Such drive assemblies are restricting because they are configured to move along a vertical axis only, thereby requiring the user to be positioned directly over the device so that a downward axial force can be applied.

Further, some known drying devices, have awkwardly-placed pumping actuators, cranks, and the like. Because of this, such devices do not typically have a flat top surface. As a result, it is difficult to stack other kitchen items on top of such devices for storage purposes. This is a major drawback where kitchen space is a premium.

Accordingly, there is a need for a drying device that overcomes these and other limitations of the prior art.

### BRIEF SUMMARY

In general, the present invention relates to a drying device configured to remove excess moisture from items, such as food, through centrifugal force caused by a spinning action. In one embodiment of the present invention, a drive assembly for a drying device includes: a driving mechanism mechanically coupled to a rotatable lid that is configured to mate with a rotatable basket, and a handle pivotally attached to a cover assembly and is configured to actuate the driving mechanism upon rotation of the handle about an axis from a first position to a second position. In some embodiments, a rod connects the handle to the driving mechanism. In other embodiments, a locking mechanism is positioned on a top side of the cover assembly and configured to prevent the handle from moving from the second position to the first position. In still other embodiments, the drive assembly comprises a rack and a pinion, where the rack is configured to slideably engage the pinion upon the rotation of the handle.

In certain embodiments of the present invention, a drying device includes: a bowl having a top edge; an opening defined by the top edge of the bowl; a basket having a plurality of apertures disposed within the bowl and configured to be rotatable about a first axis with respect to the bowl; a cover assembly removably configured to mate with the top edge of the bowl and including a top side and a bottom side; a rotatable lid attached to the bottom side of the cover assembly and configured to mate with the upper edge of the basket when the cover assembly is positioned on the top edge of the bowl; a drive assembly associated with the cover assembly and including a driving mechanism mechanically coupled to the lid and comprising a rack and a pinion; a handle pivotally attached to the cover assembly and configured to actuate the driving mechanism upon rotation of the handle about a second axis from a first position to a second position; and a rod connecting the handle and the driving mechanism. In some embodiments, a locking mechanism is positioned on the top side of the cover assembly and is configured to prevent the handle from moving from the second position to the first position. In still other embodiments, a brake button is positioned on the top side of the cover assembly and is configured to actuate a brake assembly.

### BRIEF DESCRIPTION OF THE DRAWINGS

FIG. 1 is a side view of a drying device in accordance with one embodiment of the present invention;

FIG. 2 is a cross-sectional overview of the drying device shown in FIG. 1, as taken along line 2-2 of FIG. 1;

FIG. 3 is an exploded view of a portion of the drying device shown in FIG. 1;

FIG. 4 is an exploded view of a driving mechanism in accordance with one embodiment of the present invention;

FIG. 5 is an exploded view of a braking mechanism in accordance with one embodiment of the present invention;

FIG. 6 is a top view illustration of a drying device of one embodiment of the present invention; and

FIG. 7 is a side view illustration of the drying device shown in FIG. 6.

### DETAILED DESCRIPTION OF THE DRAWINGS AND THE PRESENTLY PREFERRED EMBODIMENTS

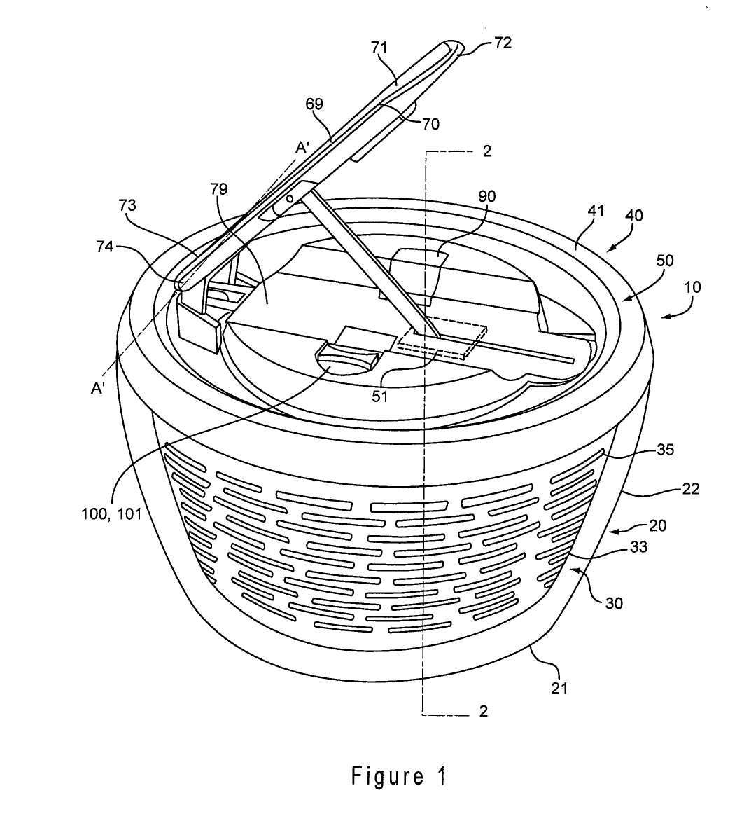

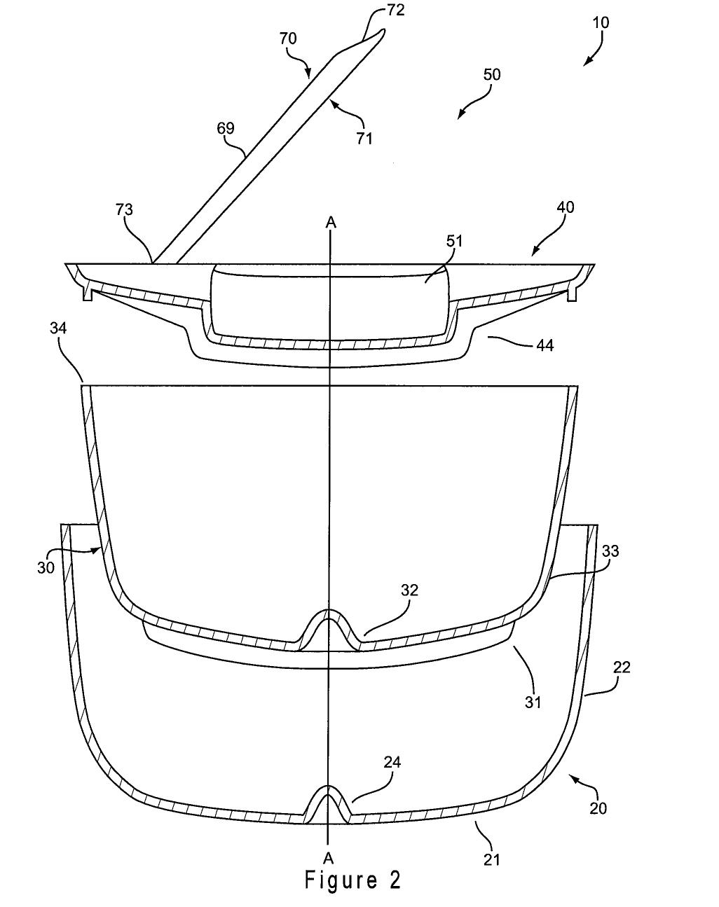

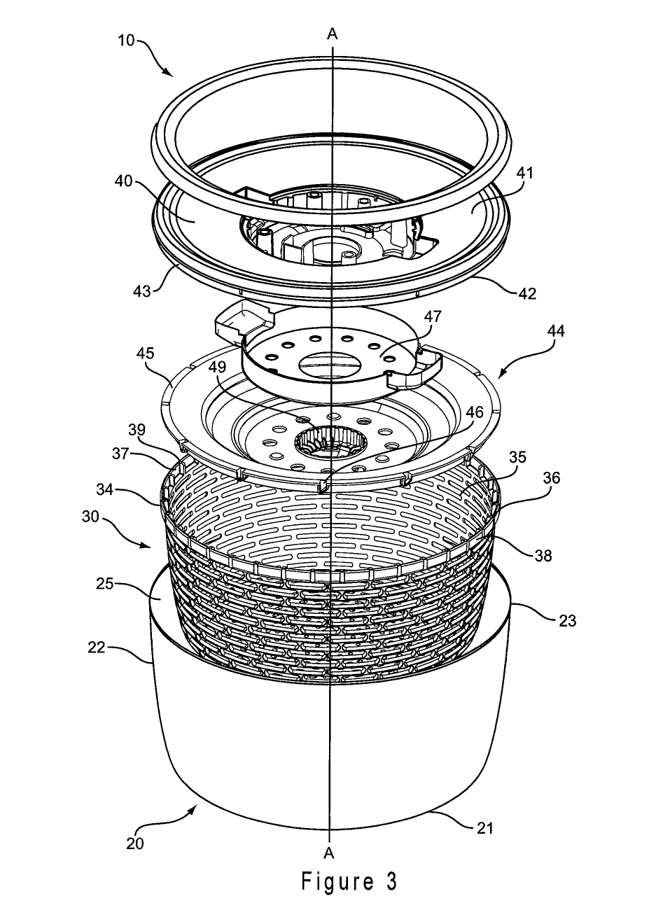

Referring to FIG. 1, one embodiment of a drying device 10 is provided. In this embodiment, the device 10 comprises a bowl 20, a basket 30 having apertures 35, a cover assembly 40 and a drive assembly 50 associated with the cover assembly 40. The bowl 20 is generally circular in shape and has a generally circular base 21. Referring now to FIG. 2, a generally conical projection 24 is formed on the bottom of the circular base 21. The device 10 has a vertical axis A that passes through the center of the bowl 20 and the generally conical projection 24. As shown in FIG. 3, the bowl 20 defines an opening 25. The bowl 20 also has sidewalls 22 that end in a defined top edge 23. The bowl 20 may be manufactured from synthetic, semi-synthetic, or other suitable materials. Examples of suitable materials include, but are not limited to, acetal plastic resin, acrylonitrile butadiene styrene, polycarbonate, styrene acrylonitrile, polypropylene and thermoplastic elastomer.

In the embodiment of FIG. 1, a basket 30 is disposed within the bowl 20. The basket 30 has a base 31 that is generally flat and circular. As shown in FIG. 2, a generally conical indentation 32 is formed in the base 31 of the basket 30, and is configured to be releasably coupled to the generally conical projection 24 of the bowl 20 when the basket 30 is placed within the bowl 20. The basket 30 is configured to rotate about the vertical axis A with respect to the bowl 20. The basket 30 also includes sidewalls 33 that define an upper edge 34. Referring back to FIG. 1, the basket 30 is configured to allow water to escape through a plurality of apertures 35 in the sidewalls 33 and the base 31. In the embodiment of FIG. 3, the upper edge 34 of the basket 30 includes a lip 36 having an inner surface 37 and an outer surface 38. A plurality of ribs 39 may be distributed circumferentially about the upper edge 34 of the basket 30 to facilitate engagement of the basket 30 with an adjoining lid 44. The basket 30 may be manufactured from synthetic, semi-synthetic materials, or other suitable materials. Examples of such materials are provided above.

Referring to the embodiment of FIGS. 1, 2 and 3 the device 10 also comprises a drive assembly 50 and a cover assembly 40 that is removably configured to mate with the top edge 23 of the bowl 20. As shown in FIG. 3, the cover assembly 40 has a top side 41 and a bottom side 42. In one embodiment, the cover assembly 40 includes a flange 43 configured to extend about the periphery of the cover assembly 40 and prevent substantial lateral movement of the cover assembly 40 when placed on the top edge 23 of the bowl 20. A lid 44 is attached to the bottom side 42 of the cover assembly 40. The lid 44 is rotatable about the vertical axis A when placed on the basket bowl and is configured to mate with the upper edge 37 of the basket 30 when the cover assembly 40 is placed upon the top edge of the bowl 20. The lid 44 may include a flange 45 extending about the periphery of the lid 44. The flange 45 includes a plurality of notches 46 configured to engage the inner surface 37 of the lip 36 of the basket 30. The lid 44 may also be removable from the cover assembly 40 to facilitate cleaning. The cover assembly 40 may further include a cap 47 to conceal the interior parts of the cover assembly 40. In one embodiment, a hub structure 48 is provided in the center of the cap 47 and engages a corresponding hub receiving component 49 of the lid 44.

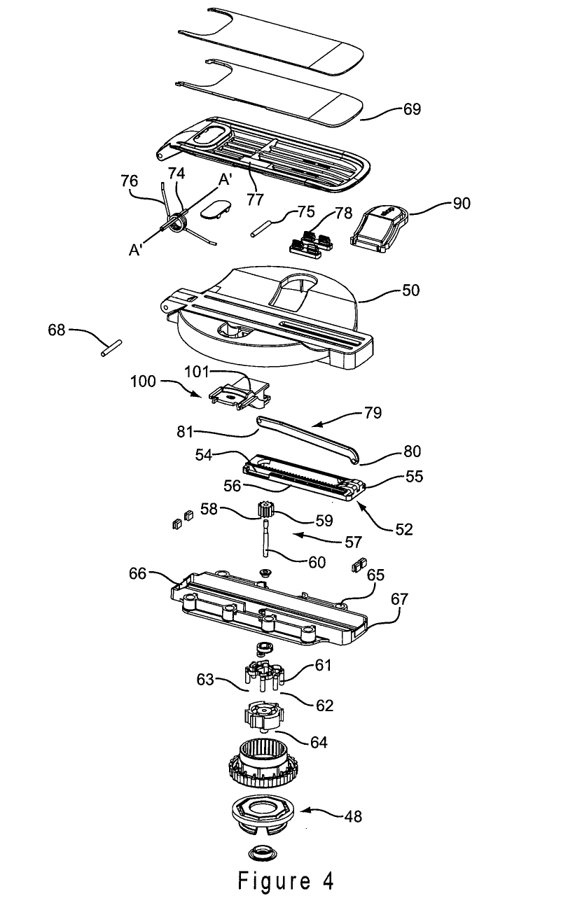

In the embodiment of FIG. 1 and 2, the drive assembly 50 is associated with the cover assembly 40. As shown in FIG. 1, the drive assembly 50 includes a handle 69 and a driving mechanism 51 mechanically coupled to the lid 44. In one embodiment, the driving mechanism 51 includes a rack 52 and a pinion 57. Referring to FIG. 4, the driving mechanism 51 also includes a frame 65 having a first end 66 and a second end 67. The rack 52 and pinion 57 are placed within the frame 65, and the rack 52 is configured to slide between the first end 66 and the second end 67 of the frame 65 upon actuation. The rack 52 may have a generally rectangular shape and an opening 53 defined through the middle of the rack 52. In some embodiments, a slot 54 is provided in the rack 52 and is configured to receive a locking mechanism 100, which will be discussed in further detail below. An end of the rack 52 may include a channel 55 to receive a pivot pin 68. A plurality of inner teeth 56 is provided within the opening 53 of the rack 52 to engage the pinion 57.

In the embodiment shown in FIG. 4, the pinion 57 is generally circular in shape with a plurality of equally spaced external teeth 58 about its periphery. The pinion 57 is configured to fit within the opening 53 of the rack 52. The inner teeth 56 of the rack 52 are configured to engage and mesh with the external teeth 58 of the pinion 57 as the rack 52 slides from the first end 66 to the second end 67 of the frame 65. An opening 59, configured to receive a shaft 60, is provided in the center of the pinion 57. The drive assembly 50 may further include a sprag assembly 61 and a clutch assembly 64 coupled to the pinion 57 via the shaft 60. See, for example, the sprag assembly disclosed in PCT/US2004/043598 entitled METHODS AND APPARATUS FOR A SALAD SPINNER, filed Dec. 22, 2004, which claims priority to U.S. patent application Ser. No. 10/845,997, filed May 14, 2004, both of which are hereby incorporated by reference herein. The sprag assembly 61 may include a number of deformable members 62 and cylindrical portions 63. The cylindrical portions 63 are configured to engage the clutch assembly 64 as the sprag assembly 61 rotates and the deformable members 62 are forced outward. It will be appreciated that many other sprag assembly and clutch assembly designs may be used in connection with the present invention.

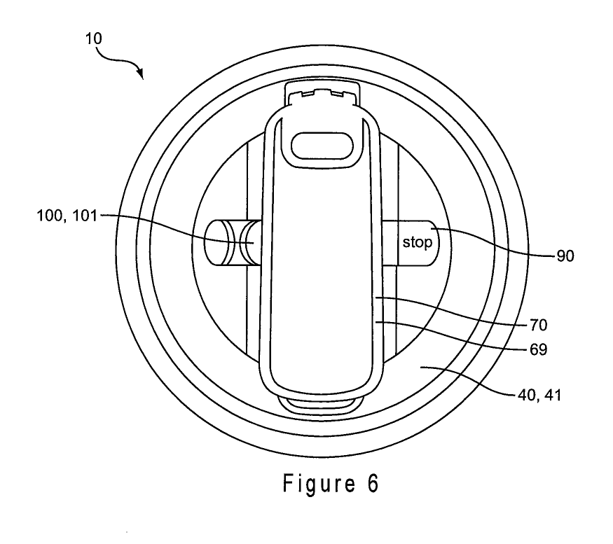

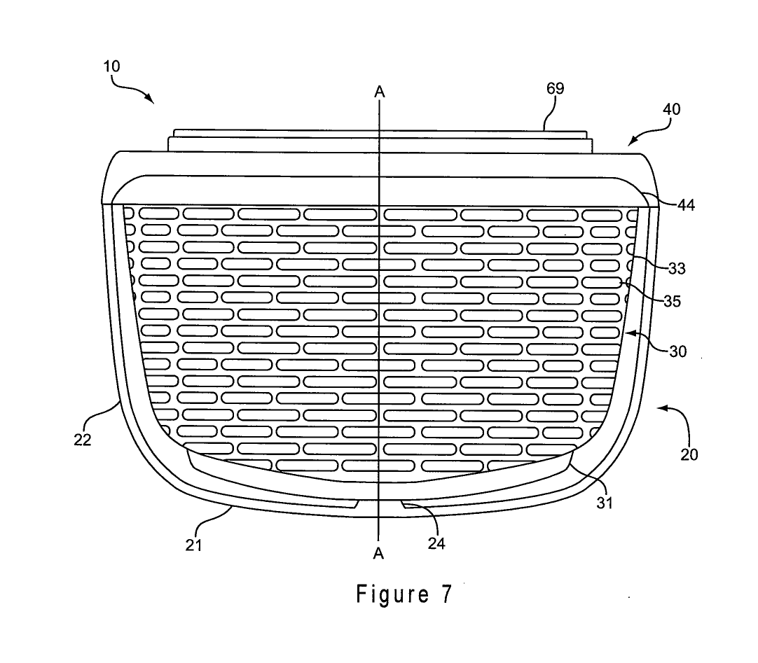

The drive assembly 50 of FIGS. 1 and 2 further includes a handle 69 configured to actuate the driving mechanism 51. The handle 69 may have a generally rectangular configuration with a top side 70, a bottom side 71, a first end 72 and a second end 73. In certain embodiments, the second end 73 of the handle 69 is pivotally attached to the top side 41 of the cover assembly 40 by a first hinge pin 74 or any other suitable fastening mechanism. The first hinge pin 74 is configured to rotate about a horizontal axis A′. As shown by FIG. 1, the handle 69 remains in a raised, first position until it is actuated by a user. Referring now to FIG. 4, a spring assembly 76 may be placed about the first hinge pin 74. The spring assembly 76 is configured to compress and expand as the handle 69 rotates about the horizontal axis A′ between the raised, first position to a lowered, second position. FIGS. 6 and 7 show top and side views, respectively, of the device 10 when the handle 69 is in the lowered, second position. In some embodiments, an opening 77 is provided on the bottom side 71 of the handle 69 and is configured to receive the locking mechanism 100 when the handle 69 is in the lowered, second position.

The locking mechanism 100 may be any suitable mechanism for retaining the handle 69 in the lowered position such as the slideable latch 101 shown in FIGS. 1 and 6. The locking mechanism 100 may be configured to move laterally with respect to the cover assembly 40 upon actuation of the locking mechanism 100 by a user. Such a slideable latch 101 releasably engages the opening 77 on the bottom side 71 of the handle 69. Further, in some embodiments, the locking mechanism 100 engages a slot 54 in the rack 52 to prevent the rack 52 from moving from the second end 67 of the frame 65 to the first end 66. Desirably, the locking mechanism 100 is also configured such that the locking mechanism 100 is prevented from moving laterally when the handle 69 is in the raised, first position, thereby preventing the locking mechanism 100 from interfering with the rotation of the handle 69 during use of the device 10. When the handle 69 is locked in the lowered, second position by the locking mechanism 100, the handle 69 lies contiguous with the cover assembly 40 and provides a substantially flat or planar top surface, as shown by FIGS. 6 and 7. This feature allows for the stacking of items on top of the device 10. As shown in FIG. 4, a bumper assembly 78 is attached to the bottom side 71 of the handle 69 that engages the top side 41 of the cover assembly 40 when the handle 69 is in the lowered, second position.

Referring back to FIG. 1, in one embodiment, the drive assembly 50 includes a rod 79 to connect the handle 69 to the driving mechanism 50. In the embodiment of FIG. 4, the rod 79 has a first end 80 and a second end 81. The rod 79 is attached to the rack 52 by positioning the pivot pin 68 through the first end 80 of the rod 79 and the channel 55 of the rack 52. The second end 81 of the rod 79 is attached to the bottom side 71 of the handle 69 by a second hinge pin 75, or other suitable fastening mechanism. When the handle 69 is in the lowered, second position, the rod 79 may be received in a groove (not shown) on the bottom side 71 of the handle 69.

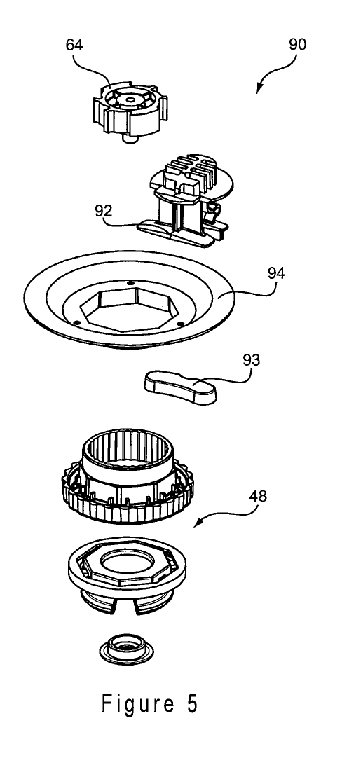

In some embodiments of the present invention, a brake button 90 is provided on the top side 41 of the cover assembly 40, as shown by FIG. 1. The brake button 90 is configured such that, when pressed, it actuates a brake assembly 91 configured to stop the rotational motion of the basket 30 and the lid 44. In the embodiment in FIG. 5, the brake assembly 91 includes an upper brake pad 92, a lower brake pad 93, and a brake disc 94. The brake disc 94 is attached to the lid 44 via a hub structure 48 and a clutch assembly 64. When the brake assembly 91 is actuated, the brake disc 94 is squeezed between the upper brake pad 92 and the lower brake pad 93. The retarding force is then communicated to the lid 44 through the intermediate hub structure 48 and the corresponding hub receiving component 49, and the rotation of the lid 44 and basket 30 is stopped. The braking assembly 91 may be disposed completely within the cover assembly 40 and concealed by the cap 47. In other embodiments, the brake assembly can involve direct frictional engagement with the lid, for example.

In operation, the user of the device 10 places wet items, including, but not limited to, food, within the basket 30 and places the cover assembly 40 upon the top edge 23 of the bowl 20. The user then applies an external force to the first end 72 of the handle 69 in order to pivotally rotate the handle 69 in the direction of the cover assembly 40 about horizontal axis A′. In some embodiments, upon the application of the force to the handle 69, a spring assembly 76 compresses as the handle 69 rotates from the raised, first position to the lowered, second position. The first end 72 of the handle 69 travels in an arcuate motion as the external force is applied to the handle 69. The rotational motion of the handle 69 is translated to the rod 79, which displaces the rack 52. The internal teeth 56 of the rack 52 slideably engage the external teeth 58 of the pinion 57 as the rack 52 travels from the first end 66 to the second end 67 of the frame 65. The linear motion of the displaced rack 52 actuates the pinion 57, which in turn may actuate a sprag assembly 61 to engage a clutch assembly 64. This engagement of the sprag assembly 61 and the clutch assembly 64 causes rotation of the lid 44 and the basket 30 about vertical axis A with respect to the bowl 20.

When the force is no longer applied, the spring assembly 76 expands and causes the handle 69 to rotate from the lowered, second position to the raised, first position. The sprag assembly 61 then disengages from the clutch assembly 64 as the rack 52 disengages from the pinion 57. The lid 44 and basket 30 spin freely when the components of the driving mechanism 50 disengage. The rotation of the basket 30 causes any moisture attached to the wet items placed in the device 10 to be propelled by centrifugal force radially outward to collect within the bowl 20. The user may repeatedly apply the external downward force to the handle 69 until the item is sufficiently dry. The user may actuate the brake assembly 91, if present, by pressing the brake button 90, which will retard the spinning of the basket 30 and the lid 44. Further, in some embodiments, when the user is finished using the device 10, the handle 69 may be rotated to the lowered, second position so that a locking mechanism 100, such as a slidable latch 101, can engage an opening 77 in the handle 69 and a slot 54 in the rack 52.

It is therefore intended that the foregoing detailed description be regarded as illustrative rather than limiting, and that it be understood that it is the following claims, including all equivalents, that are intended to define the spirit and scope of this invention.

1. A drive assembly for a drying device, said drive assembly comprising:
a driving mechanism mechanically coupled to a rotatable lid, wherein said lid is configured to mate with a rotatable basket having a plurality of apertures; and
a handle pivotally attached to a cover assembly, said handle configured to actuate said driving mechanism upon rotation of said handle about an axis from a first position to a second position.

2. The drive assembly of claim 1, further comprising a rod connecting said driving mechanism to said handle.

3. The drive assembly of claim 1, wherein said driving mechanism comprises a rack and a pinion.

4. The drive assembly of claim 3, wherein said rack is configured to slideably engage said pinion upon rotation of said handle.

5. The drive assembly of claim 3, wherein said driving mechanism further comprises a clutch assembly coupled to said pinion and a sprag assembly configured such that said sprag assembly engages said clutch assembly when said handle rotates from said first position to said second position.

6. The drive assembly of claim 1, wherein a locking mechanism is positioned on a top side of said cover assembly and is configured to prevent said handle from moving from said second position to said first position.

7. The drive assembly of claim 6, wherein said locking mechanism releasably engages an opening in said handle when said handle is in said second position.

8. The drive assembly of claim 6, wherein said locking mechanism is configured to remain stationary when said handle is in said first position.

9. A drying device, comprising:
a bowl having a top edge and an opening defined by said top edge;
a basket disposed within said bowl and rotatable about a first axis with respect to said bowl, said basket comprising an upper edge and a plurality of apertures;
a cover assembly removably configured to mate with said top edge of said bowl, said cover assembly comprising a top side, a bottom side, and a rotatable lid attached to said bottom side and configured to mate with said upper edge of said basket when said cover assembly is positioned upon said top edge of said bowl; and
a drive assembly associated with said cover assembly, said drive assembly comprising a driving mechanism mechanically coupled to said lid, said driving mechanism comprising a rack and a pinion engageable with said rack, and a handle pivotally attached to said cover assembly;
wherein said handle rotates about a second axis and moves said rack which rotates said pinion about said first axis imparting rotational energy to said lid and said basket.

10. The device of claim 9, wherein said driving assembly further comprises a rod connecting said handle to said driving mechanism.

11. The device of claim 9, wherein said driving mechanism further comprises a clutch assembly coupled to said pinion and a sprag assembly configured such that said sprag assembly engages said clutch assembly when said handle rotates from said first position to said second position.

12. The device of claim 9, wherein a locking mechanism is positioned on said top side of said cover assembly configured to prevent said handle from moving from said second position to said first position.

13. The device of claim 12, wherein said locking mechanism releasably engages an opening in said handle when said handle is in said second position;

14. The device of claim 12, wherein said locking mechanism is configured to remain stationary when said handle is in said first position.

15. A method for drying food, comprising the steps of:
providing a drying device, said device comprising:
a container having a top edge and an opening defined by said top edge;
a basket disposed within said container, said basket having a plurality of apertures and an upper edge;
a cover assembly removably configured to mate with said top edge of said container, said cover assembly comprising a bottom side and a lid attached to said bottom side and configured to mate with said upper edge of said basket when said cover assembly is positioned upon said top edge of said container;
a drive assembly associated with said cover assembly, said drive assembly comprising a driving mechanism mechanically coupled to said rotatable lid, and a handle pivotally attached to said cover assembly;
placing food containing moisture within said basket;
positioning said cover assembly upon said top edge of said container such that said rotatable lid mates with said top edge of the basket;
actuating said handle to engage said driving mechanism to rotate said lid and said basket about an axis in order to remove said moisture from said food; and
removing said cover assembly such that said food may be removed from said basket.

16. The method of claim 15, wherein said driving assembly further comprises a rod connecting said handle to said driving mechanism.

17. The method of claim 15, wherein said driving mechanism further comprises a rack and a pinion engageable with said rack.

18. The method of claim 17, wherein the step of actuating comprises pivotally rotating said handle about a second axis in the direction of the cover assembly and moving said rack which rotates said pinion.
